(19) United States
(12) Patent Application Publication
(10) Pub. No.: US 2010/0135020 A1
(43) Pub. Date: Jun. 3, 2010

(54) Modular illumination systems

(76) Inventor: Harold A. Moore, Irvine, CA (US)

Correspondence Address: STOUT, UXA, BUYAN & MULLINS LLP, 4 VENTURE, SUITE 300, IRVINE, CA, 92618, US

(21) Appl. No.: 12/657,675

(22) Filed: Jan. 25, 2010

Related U.S. Application Data
(63) Continuation of application No. 11/504,919, filed on Aug. 15, 2006, now abandoned.
(60) Provisional application No. 60/708,485, filed on Aug. 15, 2005.

(51) Int. Cl. F21S 4/00

(52) U.S. Cl. 362/249.02

(57) ABSTRACT

Lighting systems are provided which may be modular in form. Components of the systems include light emitting modules having a plurality of light emitting elements such as an array of spaced apart surface mounted or through board light emitting diodes, a power input connected to the light emitting module, and a housing assembly structured to receive the module. The housing assembly includes an attachment member for securing the housing element to a mounting surface, and a face portion effective to allow passage of light from the array of light emitting elements to a region to be illuminated when the module is received by the housing assembly.

### CROSS-REFERENCE TO RELATED APPLICATIONS

This application is a continuation of U.S. patent application Ser. No. 11/504,919, filed Aug. 15, 2006, which claimed priority to U.S. Provisional Application No. 60/708,485, filed Aug. 15, 2005; the entire disclosure of each of these applications is individually and specifically incorporated herein by this specific reference.

### FIELD OF THE INVENTION

This invention generally relates to display lighting systems and more specifically relates to a modular display lighting system that assembles and installs easily, and provides effective, energy efficient illumination, for example, illumination of merchandise or other objects on display, atmospheric lighting task lighting, safety lighting and the like.

### BACKGROUND

Retailers and other merchandise outlets, such as supermarkets, pharmacies, department stores, convenience stores and the like, use shelving assemblies to display merchandise, such as boxed items, cans, bottles, and other packages. Naturally, lighting of such merchandise displays is important for making products easy to find and identify, and attractive to consumers,. One common shelving assembly is referred to as gondola shelving. Examples of other shelving assemblies, including gondola shelving, include those described in Breslow, U.S. Pat. No. 4,934,645; Parker, U.S. Pat. No. 5,738,019; and Hardy, U.S. Pat. No. 6,041,720. Merchandise displayed by means of gondola shelving is commonly illuminated by means of overhead fluorescent tubing installed adjacent structure such as walls and ceiling. Shemitz , et al., U.S. Pat. No. 6,827,465 describes display lighting system using cantilevered fluorescent lamps for illuminating objects displayed on gondola-type shelving. Richardson, U.S. Pat. No. 6,638,088, the disclosure of which is incorporated herein in its entirety by this reference, describes lighting systems and fluorescent lamp receptacles and sockets.

In a grocery store, many foods such as juices, ice cream, vegetables, diary products and fresh meat, must be stored in refrigeration or freezer units which have special lighting requirements. For example, refrigerated cases must be properly lit as the associated shelving and thick glass doors create shadows or otherwise block outside ambient light from entering the refrigeration case. Fluorescent lighting fixtures have been used in such applications because the fluorescent tubes are brighter, more energy efficient and generate less heat than conventional incandescent bulbs. However, use of fluorescent lights has many drawbacks. The thin-walled glass of fluorescent tubes is easily broken or burnt. Fluorescent tubes have relatively short operational lives and must be frequently replaced. Conventional fluorescent tubes and ballast lighting assemblies are usually quite large and difficult to arrange in the confined space of the refrigeration unit. Removal of the fluorescent tubes for replacement or other maintenance procedures is quite cumbersome and time consuming. For these reasons, it is customary for retailers such as grocery stores to have maintenance contracts wherein all of the fluorescent tubes in the refrigeration units are replaced on a scheduled basis, which is typically well before the operational lives of the fluorescent tubes expires. Such maintenance increases the cost of operating the refrigeration or freezer units.

In addition, fluorescent tubes are far from ideal for many other reasons. For example, fluorescent tubes are only readily available in very few lengths. Thin glass walls of fluorescent tubes are easily broken or shattered, which is a safety concern. Mercury within the fluorescent tubes also presents safety concerns.

There remains a need for a lighting system which has a relatively longer operational life, is easier to maintain and has reduced maintenance costs in comparison with prior lighting systems. Additionally, a lighting system is needed which occupies less space and provides more even distribution of light to a surface or objects. Moreover, a lighting system is needed which is capable of being used in grocery stores, for example, in refrigerated or freezer units, with less concern for space constraints and without the safety concerns found in fluorescent bulb and ballast systems. Such a lighting system is needed which is preferably easily installed in place of a conventional fluorescent light fixture. The present invention fulfills these needs and provides other related advantages.

### SUMMARY

Accordingly, lighting systems are provided which are highly energy efficient, easy to manufacture, assemble and use, highly versatile, for example, modular, and suitable for use in both commercial and residential establishments.

The lighting systems of the present invention generally comprise a light emitting module including a plurality of light emitting elements, a housing assembly for receiving the module, and a power input for connecting the light emitting elements to a power source. More specifically, the plurality of light emitting elements preferably comprises an array of light emitting elements, in which individual light emitting elements are disposed in a side-by side, spaced apart relationship, for example, in one or more longitudinal rows.

The housing assembly may include structure, for example, a channel structured to slidably receive the module, or any other means of enabling the module to be inserted into or connected to the housing assembly. The housing assembly further includes an attachment member for securing the housing element to a mounting surface, for example, a wall, ceiling, baseboard, or any other suitable surface, and a face portion effective to allow passage of light from the light emitting elements through the face portion and to a region to be illuminated when the module is received in or on the housing assembly.

The plurality of light emitting elements may comprise a plurality of light emitting diodes (LEDs), for example, pronged or surface mount LEDs, or other suitable light sources, preferably those which are energy efficient to operate, relatively small in size and/or radiate a negligible or insignificant amount of heat. In some embodiments, the light emitting module comprises a circuit board, for example, a printed circuit board having surface mounted LEDs located in a spaced apart, generally linear relationship. The present systems may further include other appropriate circuitry for enabling the operation of the system, for example, by connecting the system to an LED regulated step down driver connected to a standard 120/220 vAC power source.

The attachment member of the housing is preferably structured to facilitate mounting of the system to a mounting surface such as a cabinet, wall, shelving surface or other desired surface. The attachment member may comprise an exterior surface of the housing which can receive an adhesive tape, magnetic strip or other element for enabling the system to be quickly and easily installed to the mounting surface. In an especially advantageous embodiment, the system requires no screws, bolts or similar mechanism for securing the housing to the mounting surface. In some embodiments, the system is structured to enable the system to be mounted using screws, and/or other mechanical fastening devices.

The face portion of the housing may be made of a suitable material, for example, an extruded acrylic material having a desired strength, stiffness and/or other characteristics that would make the material suitable for the purposes of the present invention. The face portion is structured to allow light from the light emitting elements to pass through the face portion. For example, the face portion may be substantially transparent or translucent, and may be clear, colored, opaque, or a combination thereof.

In some embodiments, the face portion is structured to enable light to radiate therefrom with a desired brilliance or brightness, or the face portion may be structured such that it functions to filter out one or more wavelengths of light passing therethrough. In some embodiments, the face portion includes texturing on one or both sides thereof. For example, the face portion may be light diffusive. For example, the face portion may include structure such as striations, grooves, dimpling, perforations, roughening, and the like, or combinations thereof.

The attachment member is structured to be connectable to a mounting surface. In some embodiments, the attachment member is structured to be connectable to a similar or identical attachment member of another lighting system in accordance with the invention. In a preferred embodiment, the attachment member is further structured to be removably connected to the face portion. In other embodiments, the attachment member and face portion form components of a single unitary molded element.

In an especially advantageous embodiment of the invention, the system is modular in form. For example, the system may further comprise end caps with male or female connectors configured to allowing two or more lighting systems of the present invention to be connected together, for example, by means of a modular extension member, wire harness jumpers with mating male or female connectors, or other suitable structure.

The system includes at least one lighting arrangement or lighting subsystem and a bracket element structured to receive the lighting arrangement or subsystem, the bracket being structured to be mountable to a surface. For example, the system may include a bracket element for holding one or more of the housing and module assemblies in back-to-back arrangement, or at various angles to one another, and connectors for enabling multiple housing and module assemblies to be in electrical connection with one another. In some embodiments, the face portion comprises a first extrusion, the attachment member comprises a second extrusion, and the bracket element comprises a third extrusion, the extrusions being couplable together in various arrangements.

The present lighting systems are useful in commercial applications, for example, but not limited to, merchandise displays, gondola shelving and in mullion assemblies in refrigeration and freezer units of grocery stores. For example, the present lighting systems are useful for providing effective lighting to merchandise displayed on shelving such as produce, dairy, ice cream, dry goods, clothing, jewelry, and the like that may be displayed on gondola or other types of fixture shelving. Other commercial applications that will benefit from the present invention include merchandise retailers, hospitals and other facilities. In addition, the present lighting systems are useful in many residential applications, for example, for task lighting, lighting for shelving, architectural molding, chair railing lighting, atmosphere lighting, interior cabinet lighting, lighting for work stations and border lighting. Advantageously, the present systems are energy efficient, require little maintenance, and have a long operational life, relative to conventional lighting systems used for similar purposes. Further, the present systems may be sized and structured to have a substantially smaller profile or depth, relative to the space requirements of conventional lighting systems, for example, those systems utilizing incandescent bulbs or fluorescent tubes.

In some embodiments, the system is effective to enhance the display or appearance of merchandise located near the present lighting system, and/or in attracting consumers to selected merchandise. Because of the versatility, low power requirements and other advantageous aspects of the present lighting systems, the systems can be placed and/or positioned nearly any place that the systems will be effective to increase consumer traffic, increase visibility of merchandise, highlight particular products, or achieve other goals.

Embodiments of the present invention also include merchandise display systems, such as shelving assemblies, including gondola style shelving assemblies, which include one or more of the present lighting systems installed thereon.

U.S. patent application Ser. No. 11/364,935, having common inventorship herewith, is incorporated in its entirety herein by this reference, and may provide additional information that may be helpful in better understanding some aspects of the present invention.

Any feature or combination of features described herein are included within the scope of the present invention provided that the features included in any such combination are not mutually inconsistent as will be apparent from the context, this specification, and the knowledge of one of ordinary skill in the art. In addition, any feature or combination of features may be specifically excluded from any embodiment of the present invention. Additional advantages and aspects of the present invention are apparent in the following detailed description and drawings.

### BRIEF DESCRIPTION OF THE DRAWINGS

The present invention may be more clearly understood, and the aspects and advantages thereof better appreciated, with reference to the following detailed description of and accompanying drawings of which:

FIG. 1A is a perspective, cross-sectional view of a lighting system according to the invention being positioned to an underside of a grocery store shelf for providing illumination to merchandise located below the shelf;

FIG. 1B is a perspective, cross-sectional view of the lighting system shown in FIG. 1A, the system being positioned along a wall at a location adjacent a ceiling for providing an illuminated wall border;

FIG. 1C is a cross sectional view of an end cap component of the lighting system shown in FIG. 1A.

FIG. 2 is cross-sectional view of another lighting system in accordance with the invention, which is a variation of the lighting system shown in FIG. 1A;

FIG. 3 is a perspective, cross-sectional view of another lighting system in accordance with the invention which includes a bracket element for directing light from the lighting system at an angle of about 45 degrees with respect to a mounting surface;

FIG. 4 is a perspective, cross-sectional view of yet another lighting system of the invention which includes a double-sided bracket element;

FIGS. 5A and 5B are a perspective view and a cross-sectional view of a mullion style lighting system in accordance with an embodiment of the invention, this embodiment being especially useful in a refrigerated or freezer unit of a grocery store, florist shop or the like;

FIGS. 5C and 5D are a front view and a side view of an end cap component of the system shown in FIGS. 5A and 5B;

FIG. 6 is a perspective, cross sectional view of yet a further embodiment of the invention;

FIG. 7A is a perspective view of a modular lighting system in accordance with the invention;

FIG. 7B is a perspective view of another modular lighting system in accordance with the invention;

FIGS. 8A-8D are simplified cross-sectional views of yet other embodiments of the invention useful for interior design applications such as architectural molding, baseboards and chair rails; and

FIG. 9A is a cross-sectional view of an alternative lighting system of the invention which is somewhat similar to the embodiment shown in FIGS. 5A-5D.

FIG. 9B and FIG. 9C are a front view and a side view, respectively, of an end cap assembly of the system shown in FIG. 9A.

### DETAILED DESCRIPTION

Reference will now be made in detail to presently preferred embodiments of the invention, examples of which are illustrated in the accompanying drawings. Wherever possible, the same or similar reference numbers are used in the drawings and the description to refer to the same or like parts. It should be noted that the drawings are in simplified form and are not to precise scale. In reference to the disclosure herein, for purposes of convenience and clarity only, directional terms, such as, top, bottom, left, right, up, down, over, above, below, beneath, rear, front, backward and forward, are used with respect to the accompanying drawings. Such directional terms should not be construed to limit the scope of the invention in any manner.

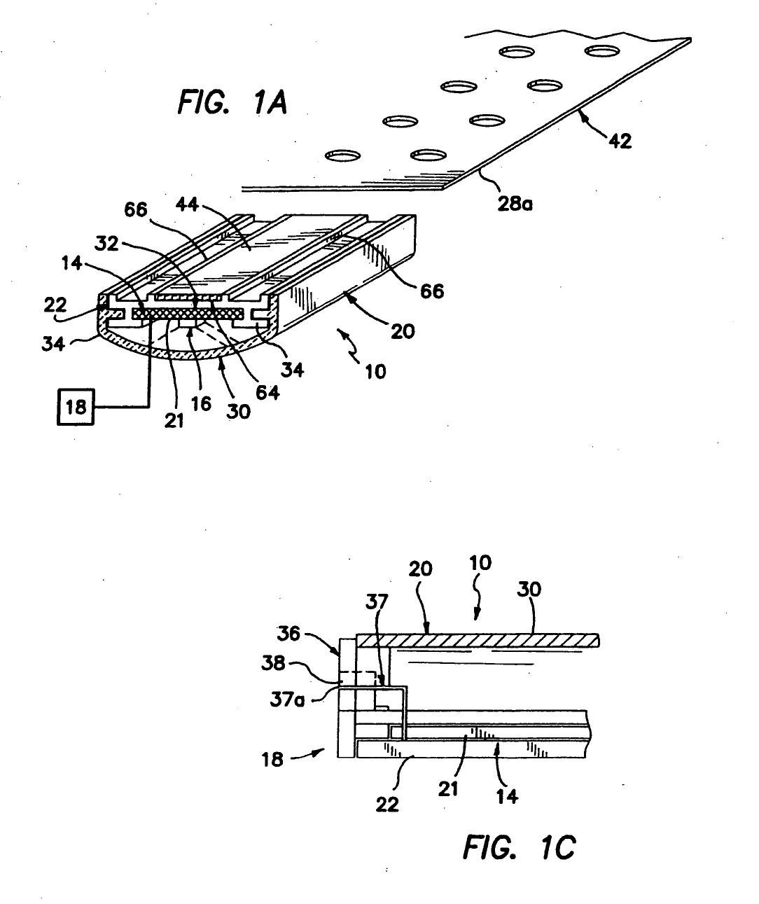

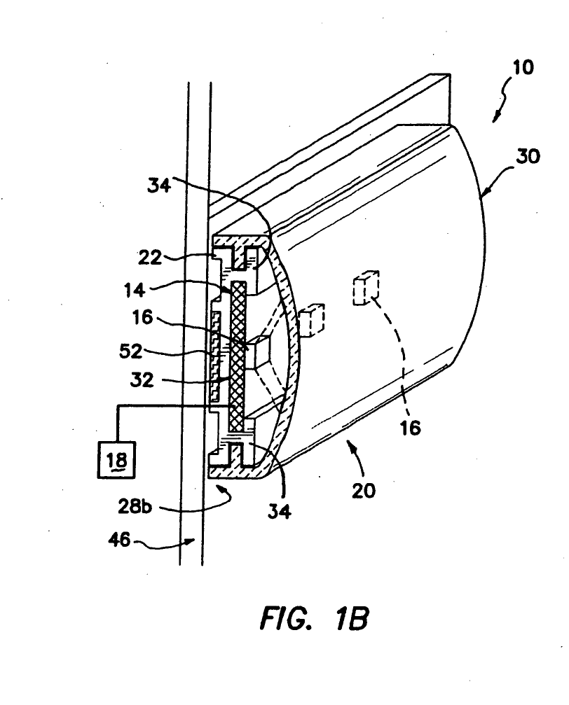

Turning now to FIGS. 1A and 1B, an exemplary embodiment of the lighting system in accordance with the invention is shown at 10. The lighting system 10 generally comprises a light emitting module 14 including a plurality of light emitting elements 16, a connector 18 for connecting the module 14 to a power source, and a housing assembly 20 structured to receive the module 14, for example, in a slidable fashion.

The module 14 may comprise a printed circuit board 21 and an array, for example, a row, of light emitting elements 16 which may comprise, for example, but not limited to, surface mounted lights or pronged LEDs, mounted thereto. Preferably, low voltage power is supplied by a step down LED driver or transformer with input 120/220 vAC to output 12 vDC or 24 vDC. The low voltage power is then distributed to 18 AWG or smaller conductors either direct to the system holder or to connector strips with male/female connectors spaced as required. The printed circuit board is populated with the LEDs and in some embodiments, other electronic components, which when powered, illuminate the face portion of the housing assembly 20 projecting light through the clear or diffused acrylic, thereby enhancing visibility of products, areas of work stations, borders of stores, and/or creating a desired atmosphere.

The housing assembly 20 includes an attachment member 22 for securing the housing assembly 20 to a mounting surface 28a and 28b in FIGS. 1A and 1B, respectively, and a face portion 30. The face portion 30 may be made of a generally transparent or translucent material, for example, but not limited to a clear acrylic material, or other material that is effective to allow passage of light from the plurality of light emitting elements 16 to a region to be illuminated when the module 14 is received by the housing assembly 20.

The module 14 is preferably removably connected to the housing assembly 20, for example, by means of a channel 32 defined in the attachment member 22. In the shown embodiment, the channel 32 is defined between spaced apart interior projections 34 each having a generally T-shaped cross-section effective to maintain the position of the module 14 during use of the system 10. Module 14 may be removed from the housing assembly 20 by sliding the module 14 in a longitudinal direction along the housing 20.

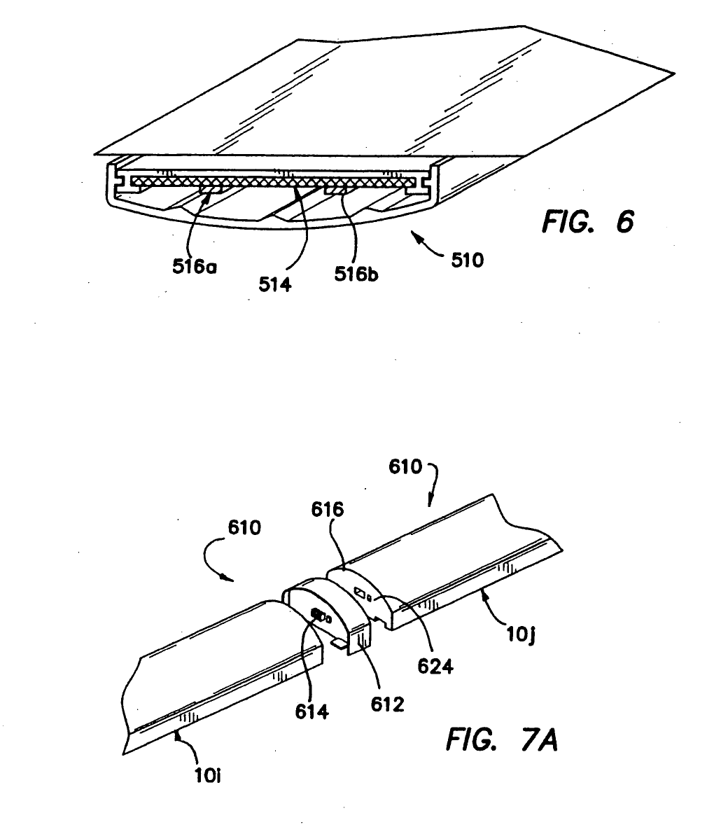

Turning now to FIG. 1C, connector 18 (shown only generally in FIG. 1A) may comprise an end cap assembly 36 of the lighting system 10. The end cap assembly 36 is generally secured to each terminal portion, i.e. one or both ends, of the housing 20. Preferably, the end cap assembly 36 is structured to enclose the printed circuit board 21 within the housing 20, and is preferably coupled to the attachment member 22 and/or the face portion 30 thereof. End cap assembly 36 is further structured and configured to facilitate electrical coupling of the system 10 with an appropriate power source, for example electrical power supplied through a step down LED driver or transformer as described elsewhere herein. For example, end cap assembly 36 includes two contact pins 37 soldered or otherwise coupled to the circuit board 21, and a socket entry cavity 38 with pin end 37a located therein. Socket entry cavity 38 is configured to receive two female sockets of a wire harness jumper, or the two female sockets of a modular connector (such as shown in FIG. 6 and discussed hereinafter), or other suitable connector. It should be appreciated that rather than the pin arrangement shown in FIG. 1C, the end cap assembly 36 may be differently configured, for example, the two contact pins may be replaced by two female sockets. End cap assembly 36 is secured to end surfaces 20a of the housing 20, for example, by means of a suitable adhesive. Alternatively or additionally, end cap assembly 36 may be configured to removably or permanently snap onto the housing 20.

For purposes of example only, it is noted that in FIG. 1A, mounting surface 28a is a bottom surface of a grocery store shelf 42 of a gondola display (not shown). Attachment member 22 is removably coupled to the shelf 42 by means of element 44, for example, adhesive tape or magnetic tape. In FIG. 1B, mounting surface 28b is a surface of an interior wall 46 of a house such that the lighting system 10 will provide an illuminated border, for example, directly beneath a ceiling. Attachment member 22 is removably coupled to the wall 46 by means of adhesive element 52, for example, adhesive tape.

Attachment member 22 may be connected to the mounting surface by any suitable means, but is preferably connected by means of magnetic tape, adhesive tape, adhesive gel, epoxy resin, glue, or any other material suitable for providing an effective temporary or permanent bond between attachment member 22 and the mounting surface. The lighting system 10 is preferably structured to enable surface mounting of the system 10 without the need for screws, bolts or other conventional attachment devices which require puncturing or destruction of the mounting surface.

Turning now to FIG. 1A, in the illustrated embodiment, the attachment member 22 includes an exterior channel or recess 64 defined between spaced apart projecting regions 66. The recess 64 may be shaped and sized for receiving peel-off adhesive tape member 44 of a commercially available, standard width. For example, the recess 64 may have a width of about 0.5 inch.

It is noted that the components of the present invention, particularly the face portion 30, the attachment member 22 may be produced by any suitable means, for example, by conventional plastics molding processes. These components are especially well suited for being manufactured using conventional extrusion methods. For example, the attachment member 22 may comprise a first extrusion and the face portion 30 may comprise a second extrusion.

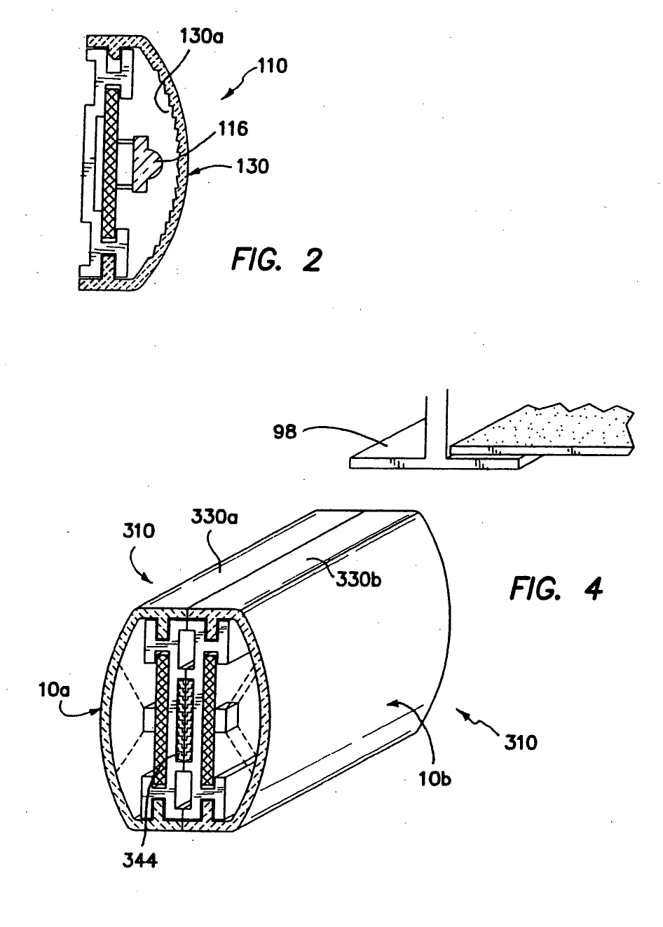

Turning now to FIG. 2, a cross-sectional view of a lighting system of the invention similar to the embodiment shown in FIGS. 1A and 1B is shown, generally at 110. Except as expressly described herein, system 110 is similar to system 10 and features of system 110 which correspond to features of system 10 are designated by the corresponding reference numerals increased by 100.

System 110 is substantially similar to system 10, with one difference being the face portion 130 of system 110 includes a light diffusing surface. For example, the face plate 130 includes parallel striations, grooves or the like defined in an interior side 130a of the face portion 130, such as shown. Persons of ordinary skill in the art will be able to appreciate that various other face portion configurations, shapes, materials, colors, textures and the like, can be provided to produce a desired lighting effect. All such variations are considered to be included within the scope of the present invention. Another distinction between system 110 and system 10 is the light emitting elements 116 of system 110 comprise through board two or four pin LEDs. The light emitting elements may be clear or colored.

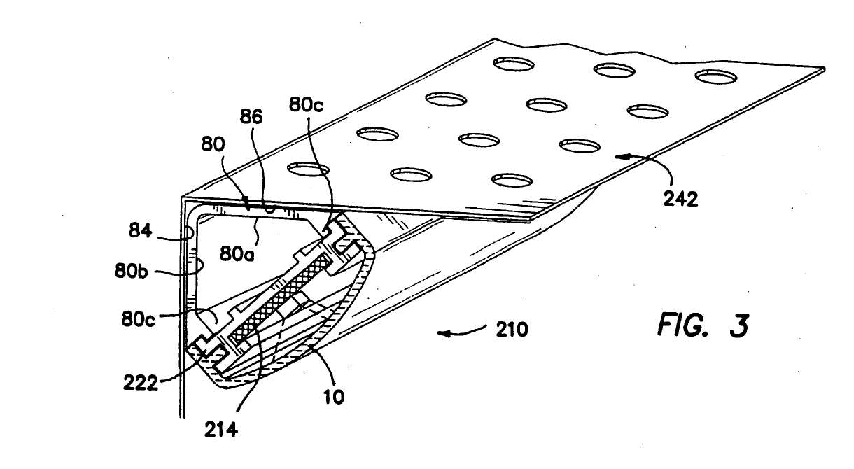

Turning now to FIG. 3, another lighting system 210 in accordance with the present invention is shown. Except as expressly described herein, system 210 is similar to system 10 and features of system 210 which correspond to features of system 10 are designated by the corresponding reference numerals increased by 200.

System 210 is substantially similar to system 10, with a primary difference being that the housing assembly 220 further comprises a bracket element 80 suitable for positioning the module 214 at an angle, for example, an angle of about 45 degrees, with respect to a mounting surface. The bracket 80 may comprise, for example, a third extrusion. The bracket 80 in the shown embodiment has a generally triangular cross-sectional shape. This configuration enables the bracket 80 to be securely mounted to first mounting surface 84 and an adjoining second mounting surface 86, for example when the surfaces are disposed at a 90 degree angle with respect to one another. For example, the first mounting surface 84 may be a back of a gondola type display, and the second mounting surface 86 may be a bottom of a gondola shelf 242 shelf projecting from the back of the display. Alternatively, the first mounting surface may be a vertical wall, and the second mounting surface may be an adjoining, horizontal ceiling. As shown, the bracket 80 includes a first planar portion 80a and a second planar portion 80b disposed at a right angle with respect to the first planar portion 80a. Planar portions may be bonded to one or both of the first and second mounting surfaces as shown by means of transfer adhesive or the like. The bracket 80 further includes projecting portions 80c sized and shaped to be securely fitted to the attachment member 222 by means of adhesive and/or in a snap-together or other permanent or separable arrangement.

Although only the 45 degree bracket configuration is shown in FIG. 3, it is to be appreciated that other embodiments of the invention include other differently configured brackets, having appropriate modifications, such other bracket configurations being effective to position the light emitting module at different angles with respect to a mounting surface, for example, but not limited to, 135 degrees, 90 degrees, 60 degrees, and 30 degrees.

FIG. 4 shows yet another system in accordance with the present invention, generally at 310. System 310 comprises two lighting assemblies or lighting subsystems 10a and 10b, which in the shown embodiment, are each identical to lighting system 10 shown in FIG. 1A and 1B. The lighting subsystems 10a and 10b are bonded together, for example by means of tape 344 or other adhesive, in a back to back arrangement. The lighting system 310 is shown as it is to be mounted at surfaces of adjoining face portions 330a and 330b to a ceiling 98, for example, to a drop ceiling having a metal T-frame. In this embodiment, the system can be used for providing a color code department locator system for customers to easily locate products.

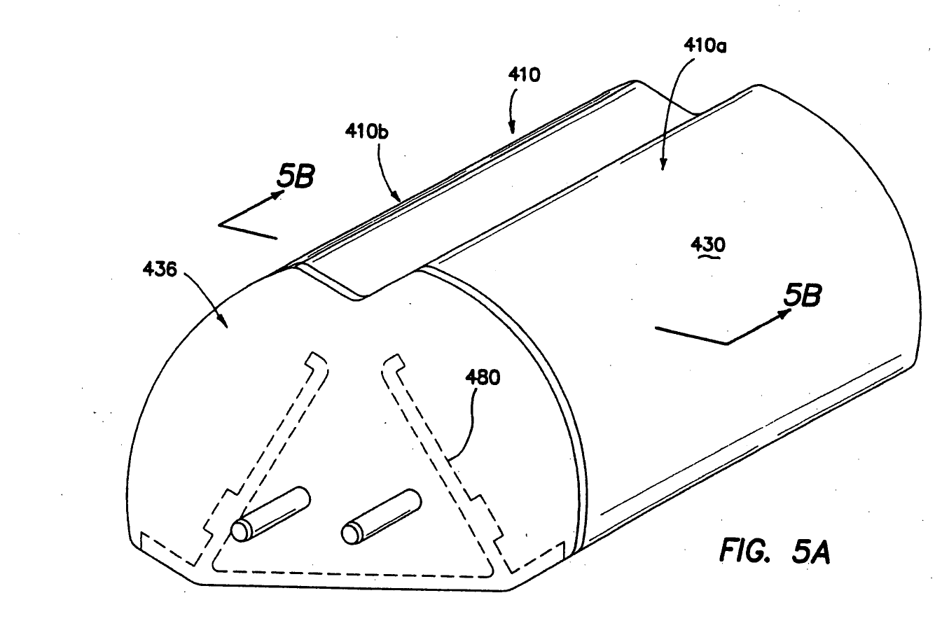

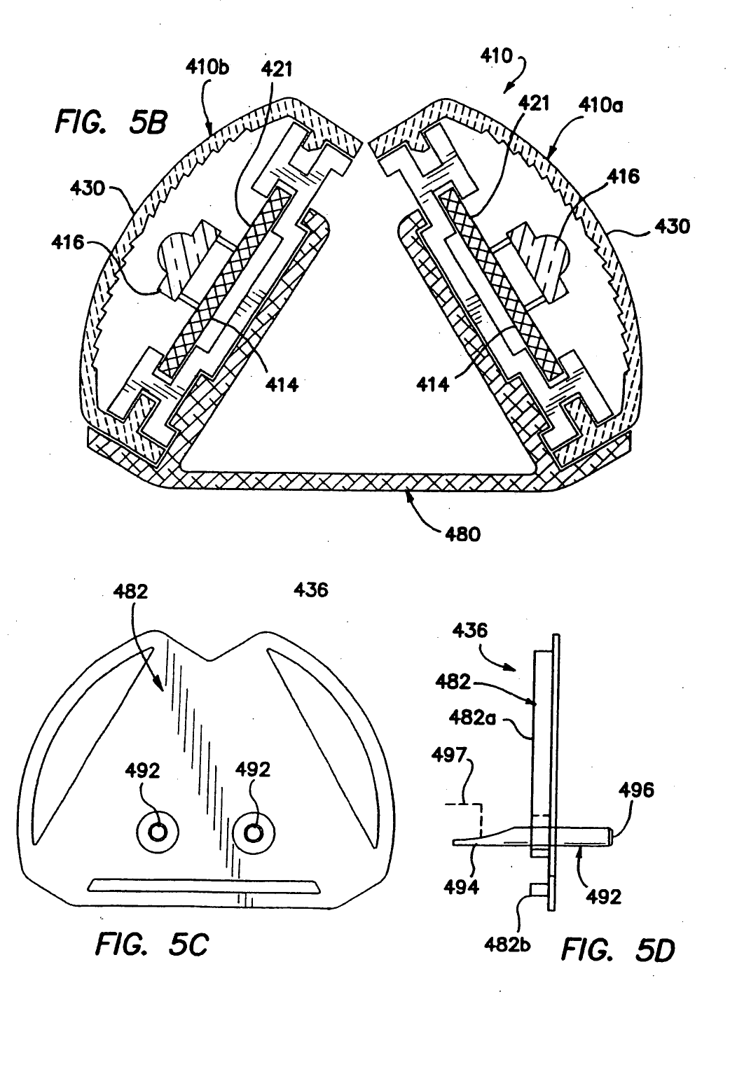

FIGS. 5A-5D illustrate yet another lighting system of the invention, generally at 410. FIGS. 5A and 5B shows a mullion style lighting system 410 having a bracket member 480 and structured to hold two elongated lighting assemblies 410a and 410b, generally in parallel with one another. An end cap 482 is fitted to the lighting assemblies 410a and 410b. FIG. 5B is a cross-sectional view is taken perpendicularly across a longitudinal axis of the system 410 across lines 5B-5B in FIG. 5A. Each of lighting assemblies 410a and 410b may be the same as lighting systems 110 (or alternatively, system 10) described and shown elsewhere herein. In this example, bracket 480 holds the assemblies 410a and 410b such that the array of light emitting elements 416 along circuit board 421 direct light outwardly. In this specific embodiment, modules 414 are disposed at an angle of about 60 degrees from one another as shown most clearly in FIG. 5B.

FIG. 5A illustrates a cross-section (in phantom lines) of bracket member 480, taken perpendicularly across the longitudinal axis thereof in FIG. 5A. It should be appreciated that, in the shown embodiment, bracket member 480 has an elongated structure with a length about equal to, and preferably no greater than, a length of the assemblies 410a and 410b. Similar to bracket 80, bracket member 480 may be an extruded component of the lighting system 410.

The end cap assembly 436, as shown in FIGS. 5A, 5C and 5D, is secured to the arrangement consisting of or comprising the bracket member 480 and assemblies 410a and 410b secured thereto. In the shown embodiment, end cap assembly 436 may include a single piece molded structure 482 having inwardly protruding portions 482a and 482b to create a secure coupling between the components of lighting system 410. The assemblies 410a and 410b may be mounted to the bracket member 489 by means of with adhesive tape, glue, or the like. In addition, it is noted that system 410 preferably includes a second, appropriately configured end cap assembly (second end cap assembly not shown) on an opposing end of the lighting system 410.

Advantageously, lighting system 410 is structured to be installable to a conventional fluorescent lamp receptacle or fluorescent lamp socket (not shown). For example, lighting system 410 may include appropriate circuitry, such as an LED driver, transformer or other circuitry effective to supply the modules 414 with low voltage power, such as described elsewhere herein. The end cap assembly 436 in the embodiment shown in FIGS. 5A-5D includes two spaced apart connector prongs 492. Each prong 492 may comprise a first end 494 that is in contact with the printed circuit boards 421 of the lighting subsystems 410a and 410b, and a second end 496 which is sized and structured to be received by, for example, attached to, a conventional fluorescent lamp receptacle or socket. First end 494 is coupled to modules 414 by any suitable means such as wiring or other connector 497. Lighting system 410 can be used in place of a conventional fluorescent tube, for example, a conventional T8 fluorescent tube. With appropriate modification to the systems of the invention shown and described herein, the present systems may also be used in place of other conventional fluorescent tubes such as T10 and T12 lamps

Typically, as known to those of skill in the art, fluorescent lamps have bi-pin contacts or double recessed contacts at each end of the fluorescent tube. The pins are separated by a predetermined center-to-center pin separation distance, which may vary according to the size of the lamp. For larger diameter lamps, the spacing can be larger for recessed double contact lamps such as some T10 and T12 lamps, but otherwise will be the same for bi-pin T8, T10 and T12 lamps. For example, a T12 double recessed contact lamp will have a larger center-to-center contact spacing than a T8 bi-pin lamp. The number 12 and the number 10 refer to the size, in eighths of an inch, of the lamp diameter.

A tombstone connector is a common design for fluorescent lamp sockets. The pins of each the lamp are inserted sideways into the socket until the lamp is centered in each socket. After being centered, the lamp is rotated about its longitudinal axis, allowing the pins to come into contact after rotation with the contacts in each socket. Another common design of fluorescent lamp sockets is a spring-biased recessed double contact socket which has one socket spring loaded so that the socket can be depressed with one end of the lamp inserted into the socket to permit enough spacing for the opposite end to be inserted into its respective socket.

With appropriate modification to the presently shown and described embodiments of the invention, the present lighting systems may be structured to be functionally connectable to at least one of a tombstone connector, a spring biased connector, or any other conventional fluorescent lamp connection fixture.

Among other uses, system 410 is especially useful in a refrigerated or freezer unit of a grocery store, florist shop and the like, for example in place of a mullion fluorescent lamp assembly. The light emitting elements produce insubstantial amount of heat and are highly energy efficient to operate.

Another embodiment of the present lighting system is shown in FIG. 6. The embodiment of FIG. 6 is similar to the embodiment of FIG. 2 except the lighting system 510 of FIG. 6 comprises a wider light emitting module 514 than module 14 and the housing assembly 520 is appropriately configured to accommodate the wider module 514. For example, module 514 may comprise two spaced apart rows 516a and 516b of a plurality of LEDs. As an alternative to the wide module 514, the system 510 may accommodate two side by side modules, for example, such as modules 14 shown in FIGS. 1A and 1B, each having a single row of LEDs.

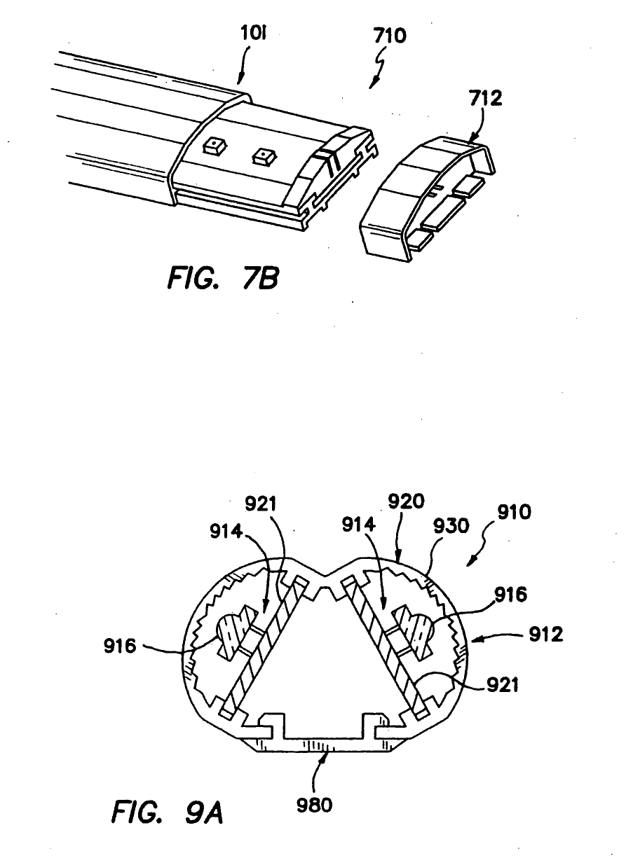

FIGS. 7A and 7B illustrate other optional components of the present invention. Specifically, a lighting systems 610 and 710, shown in FIGS. 7A and 7B respectively, are examples of modular lighting systems in accordance with the present invention. Referring now specifically to FIG. 7A, system 610 may comprise one or more modular connector units 612 structured to be effective to connect a first lighting system 10i and a second lighting system 10j. The modular connector unit 612 may include sockets or pins 614 located on opposing sides thereof, said sockets or pins 614 being connectable with pins or sockets 616 defined in appropriately configured end caps 624 of first and second lighting systems 10i and 10j, as shown. As another example, lighting system 710 in FIG. 7B includes modular connector 712 for connecting first lighting system 10i with a second lighting system (not shown in FIG. 7B).

With appropriate modifications to modular connector unit 612 and 712, as will be readily known to those of skill in the art, lighting systems 10i and 10j may be similar or identical to one or more of lighting systems 10, 110, 210, 310, 410, 510, and 910 as described and shown elsewhere herein. Further, it is to be appreciated that the connector units 612 and 712 may be configured such that lighting systems 10i and 10j are disposed at an angle to one another, for example a 90 degree angle, rather than being disposed along a common longitudinal axis as shown in FIGS. 7A and 7B. All such variations of the system 610 and 710 are considered to be included within the scope of the present invention. In addition, it is noted that modular connectors 612 and 712 may include sockets rather than pins and one or both of systems 10i and 10j may include mating sockets and pins, respectively. It is to be appreciated that there are many ways of making the present invention modular that will be appreciated by those of skill in the art upon reading the present disclosure.

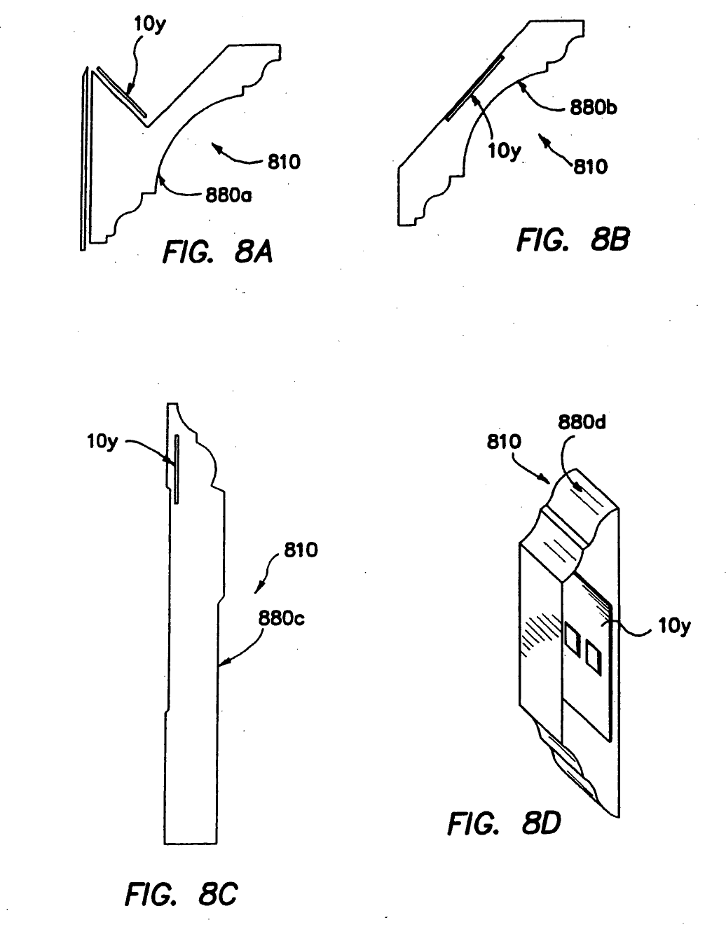

FIGS. 8A-8D are simplified cross sectional views of different embodiments of the present invention which are designed to be used in place of conventional architectural molding, so as to provide an ornate, illuminated border along a wall, ceiling, baseboard, chair railing, and the like. Lighting system 810 may comprise lighting subsystem (represented in simplified form at 10y) which may be identical to lighting system 10, and a molding bracket 880, for example, one of ornate, clear or diffuse acrylic molding brackets 880a, 880b, 880c and 880d, structured to hold the lighting subsystem 10y as shown.

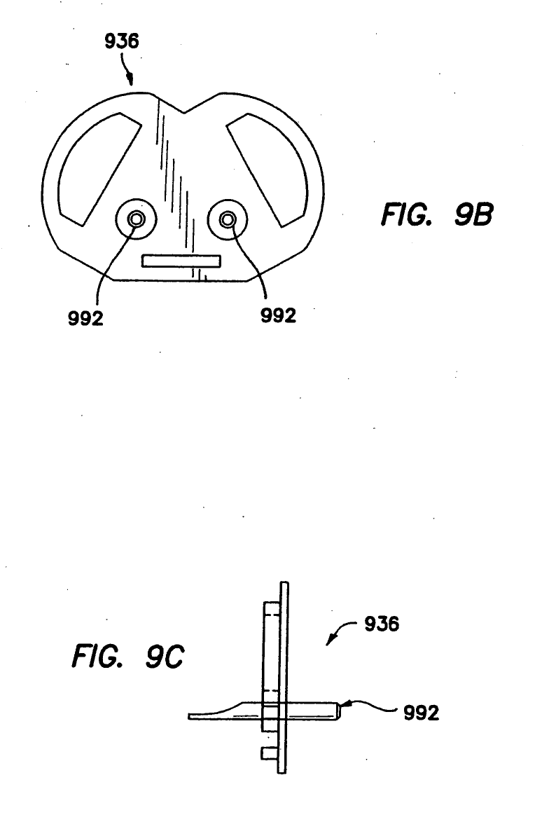

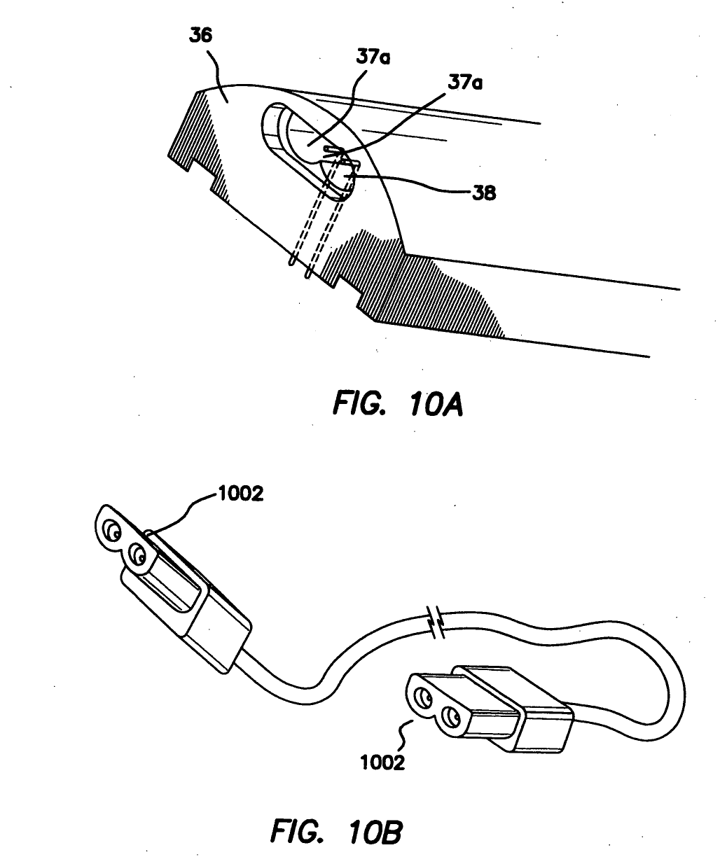

FIGS. 9A-9C show another lighting system 910 in accordance with the invention, system 910 being somewhat similar to lighting system 410 shown in FIG. 5A-5D. System 910 comprises an elongated light emitting assembly 912 including at least one module 914 comprising a circuit board 921 and a plurality of spaced apart, light emitting elements 916 coupled to the circuit board 921. System 910 further comprises an end cap assembly 936 as shown in FIGS. 9B and 9C. The end cap assembly 936 is coupled to the at least one module 914 and includes structure, for example, prongs 992 effective to enable the light emitting assembly 912 to be functionally attached to a fluorescent lamp connector (not shown), for example, a tombstone connector.

This cross-sectional view in FIG. 9A is taken perpendicularly across a longitudinal axis of system 910. The light emitting assembly 912 may have any suitable length, for example a length similar to a length of a conventional fluorescent tube. In the shown embodiment, the at least one light emitting module 914 comprises two light emitting modules positioned at an angle to one another. The light emitting elements 916 are through board Piranha LEDs. The system 910 further includes housing 920 comprising a face portion 930 structured to hold the modules 914 in a spaced apart, generally parallel arrangement, and at an angle to one another as shown. Bracket 980 is fitted to face portion 930 and may function, at least in part, to maintain structural integrity of the system 910 and prevent inward bending of the face portion 930. Bracket 980, like face portion 930, may be extrusions of acrylic materials, or other materials that can be produced by extrusion or other molding techniques.

Each one of system 410 and system 910 can be used as a direct replacement for a similarly sized fluorescent tube. For example, system 910 (or system 410) are designed to fit directly into the fluorescent lamp receptacles, e.g. tombstone connectors. Appropriate low voltage power may be supplied to system 910 by using appropriate any suitable technique, for example, by replacing the fluorescent ballast with a Class 2 LED driver, Input 120 v/220 v power is connected to the input side of the LED driver, The 12 vDC or 24 vDC output low voltage power from the LED driver is then connected to the lamp receptacle.

When required, the input 110/220 vAC may routed from one gondola fixture or other fixtures to another in pre-wired UL Listed raceway through electrical openings in the shoe or base of the fixture, or in over head UL Listed cable tray or other UL approved systems connecting into a low voltage LED driver or step down transformer. The input power is connected to UL Listed out-put 12 vDC or 24 vDC step down low voltage Single Circuit Class 2 or Multiple Circuit Class 2 UL Listed LED Driver or Transformers. In addition, the system can be driven by direct 12 vDC or 24 vDC inputs from battery sources.

The components of the present systems can be produced using conventional methods and techniques known to persons of ordinary skill in the art. For example, the face portions, attachment members, brackets, and circuit board of the light emitting modules can be produced by extruding suitable plastic materials, for example, thermoplastic materials or acrylics, into the desired physical configurations, including those configurations described herein.

The present systems may also be understood to encompass embodiments having surface mount, piranha or other LEDs mounted on a printed circuit board which is assembled (inserted or secured with adhesive) into a specially designed extrusions. Low voltage power is supplied to the printed circuit boards by step down transformers or LED drivers with input 110/220 vAC to output 12 vDC or 24 vDC then distributed either direct or to connector modules containing 18 AWG or smaller conductors with male/female connectors providing low voltage power that connects to the printed circuit boards which are installed into the acrylic extrusions. The printed circuit boards are populated with the LED's and other electronic components which, when powered with low voltage, illuminate the face of the extrusions.

The present systems can be powered with input 110/220 vAC wall mount plug in regulated step down 12 v or 24 v LED Drivers or direct wired to LED drivers or transformers with power supplied by cable/wire from a circuit breaker box that is acceptable with the Local Electrical Code and UL or routed through floor ducting or overhead cable tray connecting to UL Listed: floor or junction boxes or enclosures containing LED drivers or electronic transformers.

In view of the disclosure herein, it can be appreciated that the present lighting systems and related devices, systems, and methods can enhance a consumer's shopping experience, can enhance sales of desired merchandise, and provide other benefits to merchants and consumers. The present systems provides highly effective, versatile lighting which can be directed onto merchandise displayed on shelving such as produce, dairy, dry goods, clothing, jewelry, and the like that may be displayed on gondola or other fixture shelving. The system may be used to create a desired atmosphere and can also be used for retail department identification and easy location of the store layout with the illumination of border lighting extrusions mounted on the ceiling or wall in various colors such as: Men's department “brown”, Women's department “pink”, Produce department “green”, Dry Goods “amber”, Frozen Foods “blue”, Danger “red”, Caution “yellow”, Hazardous areas “various colors” and the like. The present systems produce minimal if any heat, and therefore are useful in illumination of shelf displays without damaging perishable or heat-sensitive items.

In addition, the present systems can be highly effective and useful in residential applications, for example, for interior design application, task lighting and the like. Further, the present systems find use in hospitals and many other facilities where safety lighting is a concern or a necessity.

Although the disclosure herein refers to certain illustrated embodiments, it is to be understood that these embodiments are presented by way of example and not by way of limitation. The intent of the following detailed description, although discussing exemplary embodiments, is to be construed to cover all modifications, alternatives, and equivalents of the embodiments as may fall within the spirit and scope of the invention.

The lighting systems attach to metal, glass, wood, acrylic, ceramic, dry wall or other materials with: peel off adhesive tape, magnetic tape or other suitable materials.

A number of publications, patents, and patent applications have been cited hereinabove. Each of the cited publications, patents, and patent applications are hereby incorporated by reference in their entireties.

While this invention has been described with respect to various specific examples and embodiments, it is to be understood that the invention is not limited thereto and that it can be variously practiced with the scope of the following claims. Multiple variations and modifications to the disclosed embodiments will occur, to the extent not mutually exclusive, to those skilled in the art upon consideration of the foregoing description. For example, various components of the present label holders can be colored to enhance the consumer's shopping experience or to enhance sale of desired merchandise. In certain embodiments, the label retention member is formed of a colored plastic. In other embodiments, the illumination source can comprise multiple colored light emitting elements, including combinations of different colors. Additionally, other combinations, omissions, substitutions and modifications will be apparent to the skilled artisan in view of the disclosure herein. Accordingly, the present invention is not intended to be limited by the disclosed embodiments, but is to be defined by reference to the appended claims.

What is claimed is:

1. A lighting system, comprising:
a light emitting module including a plurality of light emitting diodes, wherein said light emitting diodes radiate a negligible amount of heat;
a power input connector structured to provide electrical connection between a DC power source and the module;
a housing assembly structured to contain the module, the housing assembly having a first terminal end and a second terminal end; and
an end cap located on each of the first terminal end and the second terminal end, the end caps each including a socket entry cavity and the power input connectors being recessed within the socket entry cavity.

2. The system of claim 1 wherein the socket entry cavity is structured to enable electrical connection between the power input connector and a wire harness jumper.

3. The system of claim 1 wherein the power input connector does not extend exteriorly of the end cap and housing.

4. The system of claim 1 wherein the housing assembly comprises a channel suitable for receiving the module.

5. The system of claim 1 wherein the housing assembly includes a first extrusion structured to facilitate mounting of the system to a surface and a second extrusion coupled to the first extrusion and structured to permit the passage of light therethrough.

6. The system of claim 1 wherein the power input connector is substantially entirely recessed within the socket entry cavity.

7. The system of claim 1 wherein the module comprises a circuit board.

8. The system of claim 1 wherein the module comprises a printed circuit board.

9. The system of claim 1 wherein the end cap and the power input connector are structured to enable electrical connection between the module and a low voltage power source.

10. The system of claim 9 wherein the end cap and the power input connector are structured to enable electrical connection between the module and an LED driver or transformer.

11. The system of claim 1 further comprising a flexible modular connector structured to enable the lighting system to be electrically coupled to an identical lighting system.

12. A method of illuminating a merchandise display using a DC power source comprising:
placing a lighting system in a location suitable to illuminate said merchandise, the lighting system structured to utilize a DC power source and comprising
a light emitting module including a plurality of light emitting diodes, wherein said light emitting diodes radiate a negligible amount of heat;
a power input connector structured to provide electrical connection between a DC power source and the module;
a housing assembly structured to contain the module, the housing assembly having a first terminal end and a second terminal end; and
an end cap located on each of the first terminal end and the second terminal end, the end caps each including a socket entry cavity and the power input connectors being recessed within the socket entry cavity, connecting said lighting system to a DC power source and activating said lighting system to pass current through the light emitting diodes, thereby illuminating said merchandise.

13. The method of claim 12 wherein the socket entry cavity of said housing assembly is structured to enable electrical connection between the power input connector and a wire harness jumper.

14. The method of claim 12 wherein the housing assembly comprises a channel suitable for receiving the module.

15. The method of claim 12 wherein the housing assembly includes a first extrusion structured to facilitate mounting of the system to a surface and a second, at least partly translucent, extrusion coupled to the first extrusion and structured to permit the passage of light therethrough.

16. The method of claim 12 wherein the power input connector of said lighting system is substantially entirely recessed within the socket entry cavity.

17. The method of claim 12 wherein the light emitting module of said lighting system comprises a circuit board.

18. The method of claim 12 wherein the light emitting module of said lighting system comprises a printed circuit board.

19. The method of claim 18 wherein the end cap and the power input connector of the lighting system are structured to enable electrical connection between the module and an LED driver or transformer.

20. The method of claim 12 wherein the lighting system further comprises a flexible modular connector structured to enable the lighting system to be electrically coupled to an identical lighting system.
